(19) United States
(12) Patent Application Publication
(10) Pub. No.: US 2017/0130684 A1
(43) Pub. Date: May 11, 2017

(54) AIR INTAKE SHUT-OFF VALVE AND METHODS THEREOF

(71) Applicant: CS&P Technologies, LP, Cypress, TX (US)

(72) Inventor: Kennis Baskin, Cypress, TX (US)

(73) Assignee: CS&P Technologies, LP, Cypress, TX (US)

(21) Appl. No.: 14/937,173

(22) Filed: Nov. 10, 2015

(51) Int. Cl. F02M 35/10; F02D 41/00

(52) U.S. Cl. CPC F02M 35/10255; F02D 41/0002; F02D 41/0097

(57) ABSTRACT

An air intake shut-off valve comprising a valve housing, a pivot shaft, an actuator shaft, a valve disk, a solenoid having a trip rod, a service port cover, an air inlet and an air outlet is disclosed. A first end of the pivot shaft has an “L” shaped notch in the first end and a second end attaches to the valve disk. The pivot shaft rotates about the actuator shaft from a first position to a second position. A first end of the trip rod extends through the valve housing and engages the “L” shaped notch in the first position and the first end of the trip rod disengages from the “L” shaped notch in the second position. The valve disk covers the air outlet in the second position. A method of the using the air intake shut-off valve is also discussed.

### PRIOR RELATED APPLICATIONS

Not Applicable (N/A)

### FEDERALLY SPONSORED RESEARCH STATEMENT

N/A

### REFERENCE TO MICROFICHE APPENDIX

N/A

### FIELD OF INVENTION

The present invention relates generally to a valve and, more particularly, to an air intake shut-off valve for a combustions engine or machine and methods thereof.

### BACKGROUND OF THE INVENTION

If present in the ambient atmosphere, hydrocarbons (e.g., methane, natural gas) can become a serious problem when attempting to control or stop an internal combustion engine.

An engine draws ambient air through an engine air intake system. When sufficient hydrocarbons are present in the ambient air, the engine intake system draws a hydrocarbon-rich air mixture into the engine, permitting the engine to run regardless of whether a hydrocarbon fuel (e.g., diesel) is added or not. Typically, the engine (rpms) may be controlled by regulating the fuel, but not always. Sometimes the rpms can run-away on the rich air-hydrocarbon mixture without any need for additional fuel. If this situation is left unchecked, the engine may be damaged or destroyed.

To overcome this problem, an air intake shut-off valve is installed in the engine air intake system, providing a shut-off for the ambient air. However, commercially available air intake shut-off valves leave much to be desired. Most air intake valves have a split-line (i.e., seam) in their housing. Often, this split-line (or seam) in the housing leaks, causing the engine air intake system to leak and the engine to lose performance.

Traditionally, air intake shut-off valves were constructed with a two-piece housing. The two pieces were bolted together with a gasket or O-rings to seal the valve, forming a seam between the pieces. Often, these air intake shut-off valves leaked pressurized air along the seam, causing a loss of engine charge air boost. Sometimes, this leakage causes loss of up to about 10-15% of engine horse power. In applications using ten engines, this represents the loss of an entire engine.

Many air intake shut-off valves cannot handle the environmental requirements of about 75 psi and 500° F.; and others cannot survive the vibrational conditions. This leads to false trips of the valve. In many applications, a false trip can be disastrous. In large engines with dual turbochargers, an air intake shut-off valve is installed on each engine air intake system. Each engine air intake system draws ambient air for its half of the engine. If one air intake shut-off valve trips but the other does not, one side of the engine will shut off but the other will not. If this situation is left unchecked, the engine may be damaged or destroyed.

Thus, a reliable, seamless air intake shut-off valve is needed to close the engine air intake and to stop the engine, increasing safety and reducing repair or replacement costs.

### SUMMARY OF THE INVENTION

In an embodiment, an air intake shut-off valve, comprises a seamless valve housing having an air inlet and an air outlet; a pivot shaft having a first end and a second end, wherein the pivot shaft is disposed within the valve housing, wherein the pivot shaft has an “L” shaped notch in the first end and wherein the pivot shaft rotates about an actuator shaft from a first position to a second position; a solenoid having a trip rod assembly having a first end and a second end, wherein the solenoid is attached to the valve housing, wherein the first end of the trip rod assembly extends through the valve housing and engages the “L” shaped notch in the first position and wherein the first end of the trip rod assembly disengages from the “L” shaped notch in the second position; a valve disk attached to the second end of the pivot shaft, wherein the valve disk covers the air outlet in the second position, wherein the valve housing has a service port adjacent to the valve disk in the first position and wherein a service port cover is attached to the valve housing.

In an embodiment, a reset handle is attached to the first end of the actuator shaft. In an embodiment, the reset handle rotates the actuator shaft from the second position to the first position, opening the air intake shut-off valve.

In an embodiment, the reset handle rotates from about 40 degrees to about 80 degrees from the second position to the first position (and any range or value there between). In an embodiment, reset handle rotates from about 60 degrees to about 70 degrees from the second position to the first position (and any range or value there between). In an embodiment, the reset handle rotates from about 65 degrees from the second position to the first position.

In an embodiment, a manual trip handle is attached to the second end of the trip rod assembly, wherein the trip rod assembly disengages from the “L” shaped notch when the manual trip handle is withdrawn.

In an embodiment, the valve housing is made of the group consisting of metals, plastics and combinations thereof. In an embodiment, the valve housing is made of cast aluminum or molded plastic.

In an embodiment, the valve disk is made of the group consisting of metals, plastics and combinations thereof. In an embodiment, the valve disk is made of a carbon-filled polyether ether ketone (PEEK) or a polyetherimide (PEI). In an embodiment, the valve disk is made of a carbon-filled polyether ether ketone (PEEK).

In an embodiment, a solenoid insulator is disposed between the solenoid and the valve housing, wherein the solenoid insulator is made of the group consisting of laminates, plastics and combinations thereof. In an embodiment, the solenoid insulator is made of a G10 Glass reinforced epoxy laminate.

In an embodiment, the air inlet and the air outlet are between about 2 inches in diameter to about 14 inches in diameter. In an embodiment, the air inlet and the air outlet are about 4 inches in diameter.

In an embodiment, the air intake shut-off valve operates at temperatures from about −4° F. to about 500° F. and at pressures up to about 75 psi.

In an embodiment, the solenoid is in the normally closed position and the air intake shut-off valve is in the normally open position.

In an embodiment, the service port cover and the solenoid are attached to the valve housing with fasteners, wherein the fasteners are safety wired to prevent loosening.

In an embodiment, a method of using the air intake shut-off valve, comprises the steps: fluidly connecting an air inlet system of an engine or a machine to the air inlet of the air intake shut-off valve; fluidly connecting the air outlet of the air intake shut-off valve to a combustion chamber of the engine or machine; running the engine or machine on a mixture of air and fuel; and closing the air intake shut-off valve when the engine or machine speed cannot be controlled by metering fuel rate.

In an embodiment, the method further comprises the steps: electrically connecting the air intake shut-off valve to a control system; monitoring the engine or machine speed using the control system; and closing the air intake shut-off valve when the engine or machine speed reaches a trip threshold. In an embodiment, the trip threshold is from about 2400 rpm to about 7000 rpm (and any range or value there between).

These and other objects, features and advantages will become apparent as reference is made to the following detailed description, preferred embodiments and examples, given for the purpose of disclosure, and taken in conjunction with the accompanying drawings and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a further understanding of the nature and objects of the present invention, reference should be made to the following detailed disclosure, taken in conjunction with the accompanying drawings, in which like parts are given like reference numerals, and wherein:

FIG. 1 illustrates a cutaway, top view of a 3D rendering of an air intake shut-off valve in a closed position according to an embodiment of the present invention;

FIG. 2 illustrates a cutaway, top view of a 3D rendering of an air intake shut-off valve in an open position according to the embodiment of the present invention;

FIG. 3 illustrates a cutaway, side view of a 3D rendering of an exemplary electronically-actuated solenoid for an air intake shut-off valve according to the embodiment of the present invention;

FIG. 4A illustrates a top view of a 3D rendering of an air intake shut-off valve in a closed position according to an embodiment of the present invention;

FIG. 4B illustrates a bottom view of a 3D rendering of the air intake shut-off valve shown in FIG. 4A;

FIG. 5 illustrates an isometric view of a 3D rendering of an air intake shut-off valve in an open position according to an embodiment of the present invention;

FIG. 6 illustrates an exploded, side view of the air intake shut-off valve shown in FIGS. 4A-4B and 5;

FIG. 7A illustrates an exploded, side view of the exemplary electrically-actuated solenoid shown in FIG. 3;

FIG. 7B illustrates an exploded, side view of another exemplary electrically-actuated solenoid according to an alternative embodiment of the present invention;

FIG. 8A illustrates a top view of an air intake shut-off valve in a closed position according to an embodiment of the present invention;

FIG. 8B illustrates a cross-sectional, A-A side view of the air intake shut-off valve shown in FIG. 8A;

FIG. 8C illustrates a detailed, cross-sectional, A-A side view of the air intake shut-off valve shown in FIG. 8B;

FIG. 8D illustrates a bottom view of the air intake shut-off valve shown in FIG. 8A;

FIG. 9A illustrates a top view of an air intake shut-off valve according to an embodiment of the present invention;

FIG. 9B illustrates a cross-sectional, B-B side view of the air intake shut-off valve shown in FIG. 9A;

FIG. 9C illustrates a cross-sectional, top view of the air intake shut-off valve shown in FIG. 9A;

FIG. 10A illustrates a side view of an air intake shut-off valve according to an embodiment of the present invention as installed on an exemplary diesel engine with a turbocharger;

FIG. 10B illustrates a top view of the air intake shut-off valve shown in FIG. 10A;

FIG. 11A illustrates a front view of a 3D rendering of a pair of air intake shut-off valves as installed on an exemplary diesel engine with dual turbochargers, wherein an air inlet from the turbochargers and an air outlet to the engine are shown;

FIG. 11B illustrates a front view of a 3D rendering of the pair of air intake shut-off valves shown in FIG. 11A;

FIG. 12A illustrates a method of using the air intake shut-off valve according to an embodiment of the present invention;

FIG. 12B illustrates a method of using the air intake shut-off valve with a computing device according to an embodiment of the present invention; and

FIG. 13 illustrates an exemplary computing device for the method shown in FIG. 12B.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein, but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

### Air Intake Shut-Off Valve Assembly

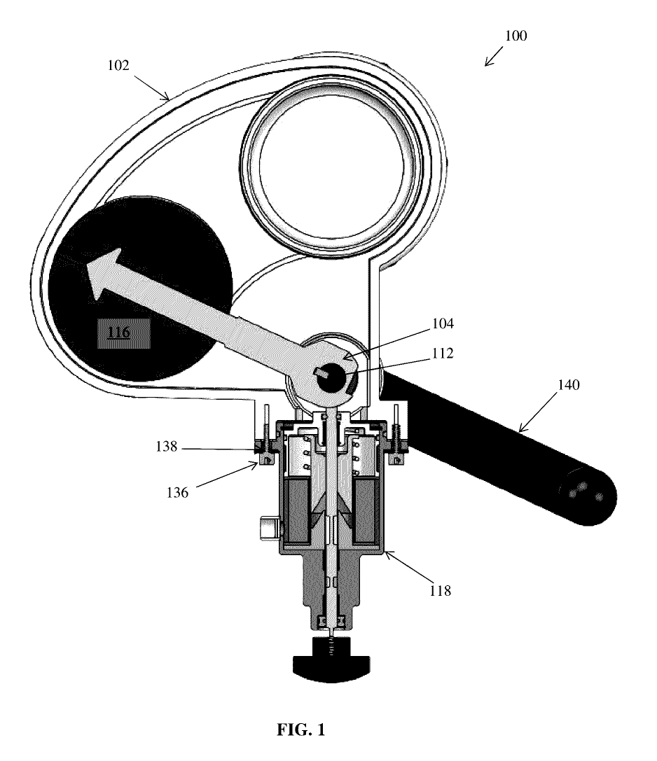

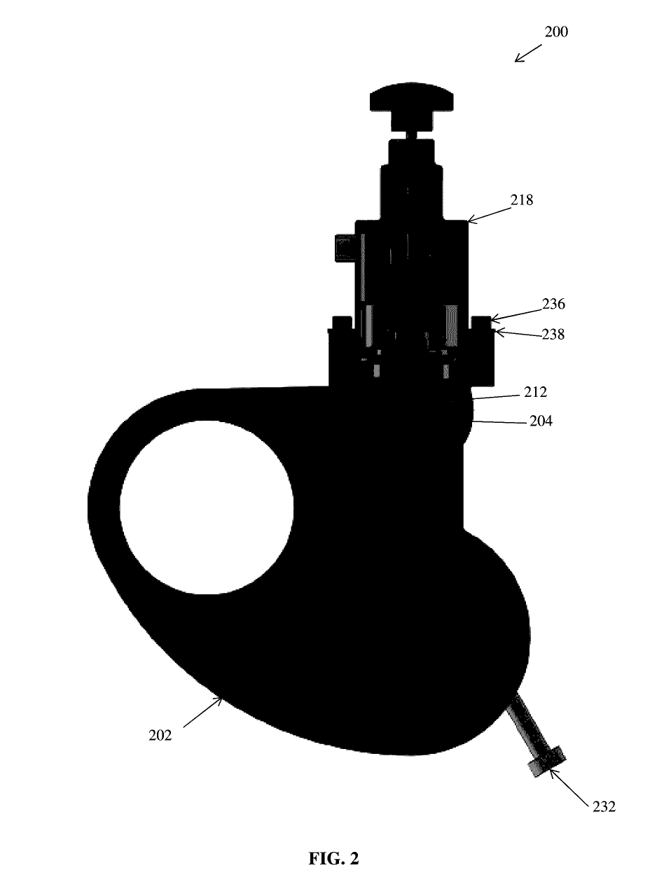

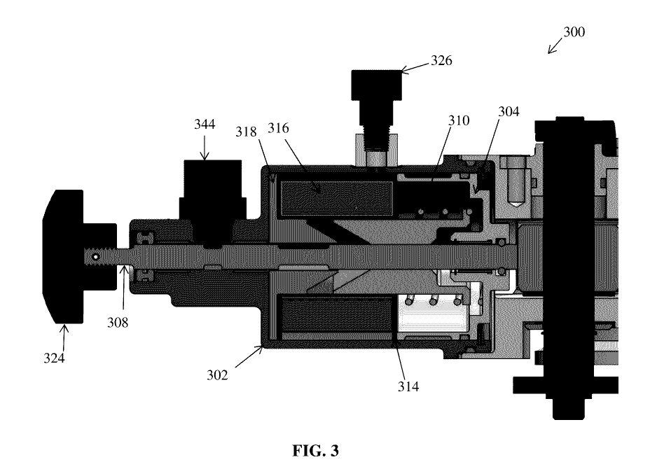

FIGS. 1-9 illustrate an air intake shut-off valve according to an embodiment of the present invention. FIG. 1 is a cutaway, top view of a 3D rendering of an air intake shut-off valve in a closed position 100 according to an embodiment of the present invention; and FIG. 2 is a cutaway, top view of a 3D rendering of an air intake shut-off valve in an open position 200 according to the embodiment of the present invention. As shown in FIGS. 1-2, the air intake shut-off valve 100, 200 comprises a valve housing 102, 202, a pivot shaft 104, 204, a solenoid assembly 118, 218 having a trip rod assembly 308, 708 (see e.g., FIGS. 3 &7A-7B) and actuator shaft 112, 212 and a valve disk 116, 216. In an embodiment, the air intake shut-off valve comprises a valve housing 102, 202, a pivot shaft 104, 204, a solenoid assembly 118, 218 having a trip rod assembly 308, 708 (see e.g., FIGS. 3 & 7A-7B) and actuator shaft 112, 212 and a valve disk 116, 216, a washer 138, 238, a fastener 136, 236 and a handle 140, 240. In an embodiment, the air intake shut-off valve 100, 200 is in the normally open position and the solenoid 118, 218 is in the normally closed position.

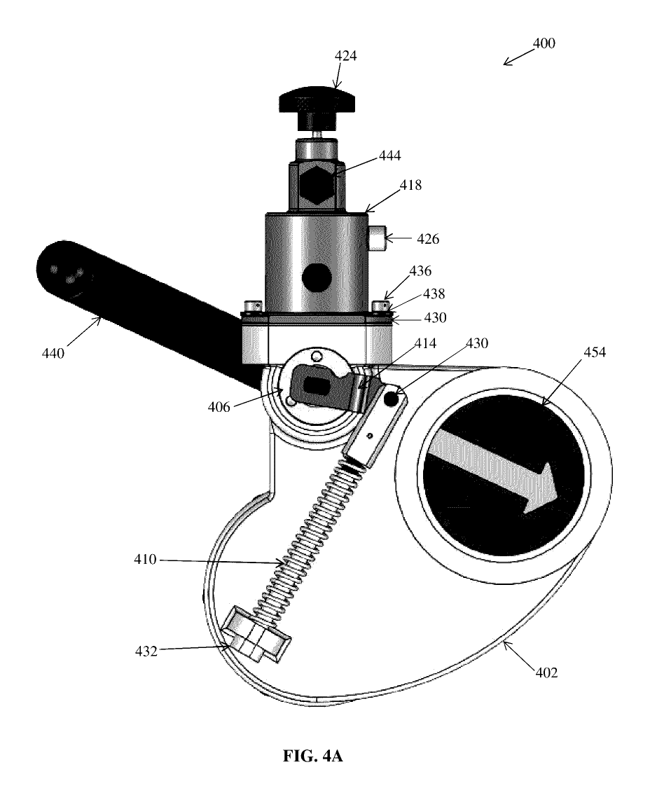

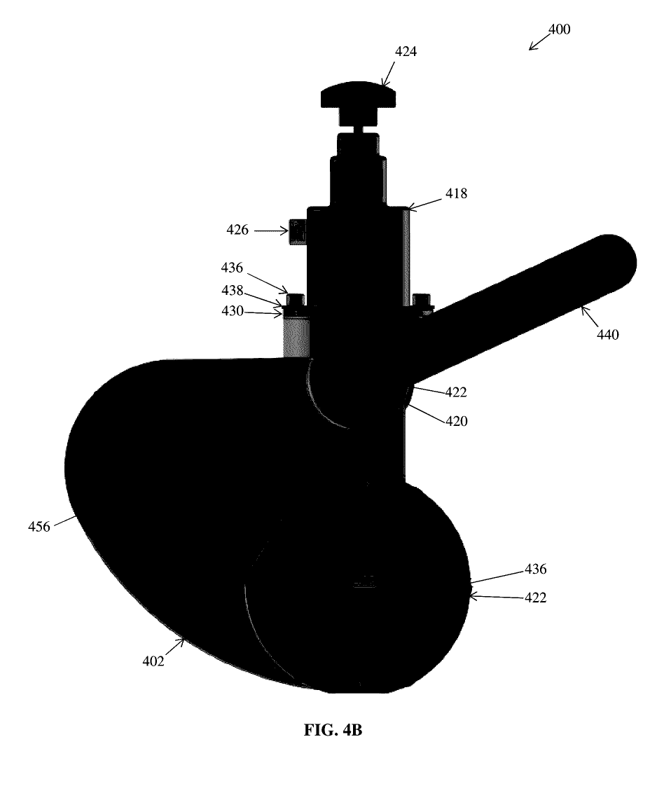

In an embodiment, the valve housing 102, 202 has an air inlet 454 and an air outlet 456. (See e.g., FIGS. 4A-4B). In an embodiment, the valve housing 102, 202 is seamless to reduce the potential for leakage of pressurized air.

In an embodiment, the air inlet 454 and the air outlet 456 may be between about 2 inches in diameter and about 14 inches in diameter (and any range or value there between). (See e.g., 4A & 4B). In an embodiment, the air inlet 454 and the air outlet 456 may be about 2 inches in diameter to about 14 inches in diameter (and any range or value there between). In an embodiment, the air inlet 454 and the air outlet 456 may be about 4 inches in diameter. In an embodiment, the air inlet 454 and the air outlet 456 may be the same size. In an embodiment, the air inlet 454 and the air outlet 456 may be a different size.

In an embodiment, the valve housing 102, 202 may be made of any suitable material capable of withstanding temperatures between about −4° F. and about 500° F. (and any range or value there between) and pressures up to about 75 psi (and any range or value there between). Suitable materials include, but are not limited to, metals, plastics and combinations thereof. In an embodiment, the valve housing 102, 202 may be made of molded plastic or cast aluminum. In an embodiment, the valve housing 102, 202 is made of cast aluminum.

In an embodiment, the pivot shaft 104, 204 has a first end and a second end, wherein the pivot shaft has an “L” shaped notch in the first end. In an embodiment, the pivot shaft 104, 204 rotates with the actuator shaft 112, 212 from a first position to a second position or from the second position to the first position. In an embodiment, the pivot shaft 104, 204 rotates counterclockwise with the actuator shaft 112, 212 from a first position to a second position or clockwise with the actuator shaft 112, 212 from the second position to the first position.

In an embodiment, the pivot shaft 104, 204 may be made of any suitable material. Suitable materials include, but are not limited to, steel, stainless steel and combinations thereof. In an embodiment, the pivot shaft 104, 204 is made of stainless steel.

In an embodiment, the pivot shaft 104, 204 rotates counterclockwise with the actuator shaft 112, 212 from a first position to a second position and the valve disk 116, 216 covers and seals the air outlet 456 in the second position; or clockwise with the actuator shaft 112, 212 from the second position to the first position and the valve disk 116, 216 uncovers and unseals the air outlet 556 in the first position. (See e.g., FIGS. 4B & 5).

In an embodiment, the actuator shaft 112, 212 may be made of any suitable material. Suitable materials include, but are not limited to, steel, stainless steel and combinations thereof. In an embodiment, the actuator shaft 112, 212 is made of steel.

In an embodiment, the valve disk 116, 216 is attached to the second end of the pivot shaft 104, 204. The valve disk 116, 216 may be made of any suitable material capable of withstanding temperatures between about −4° F. and about 500° F. (and any range or value there between) and pressures up to about 75 psi (and any range or value there between). Suitable materials include, but are not limited to, plastics, and combinations thereof. In an embodiment, the valve disk 116, 216 may be made of a carbon-filled polyether ether ketone (PEEK) or a polyetherimide (PEI) (i.e., Ultem™). In an embodiment, the valve disk 116, 216 may be made of a carbon filled polyether ether ketone (PEEK).

The solenoid 118, 218 may be any suitable solenoid having a trip rod assembly. Suitable solenoids include, but are not limited to, electrically actuated solenoids, pneumatically-actuated solenoids and hydraulically-actuated solenoids. Solenoids are well known in the art.

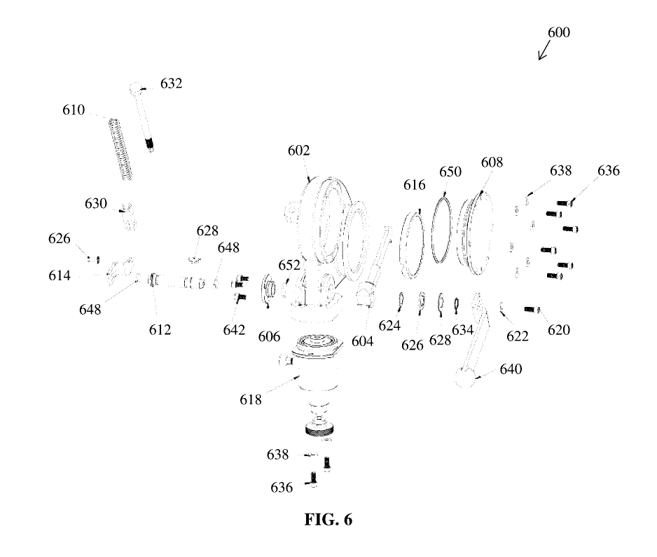

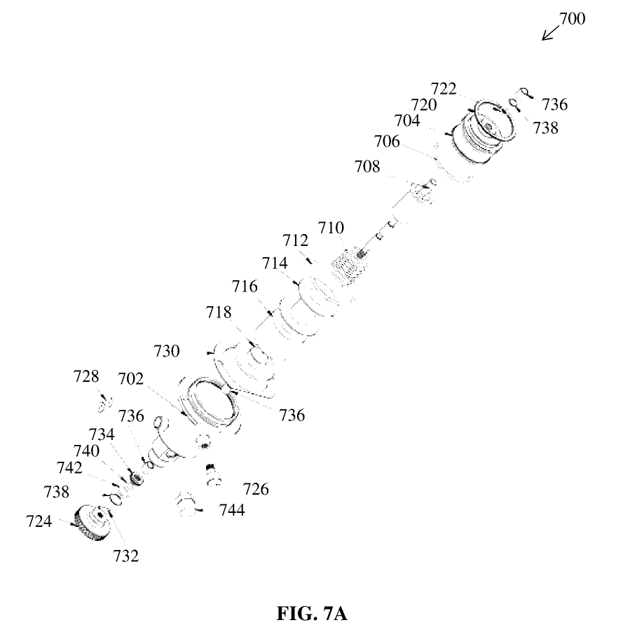

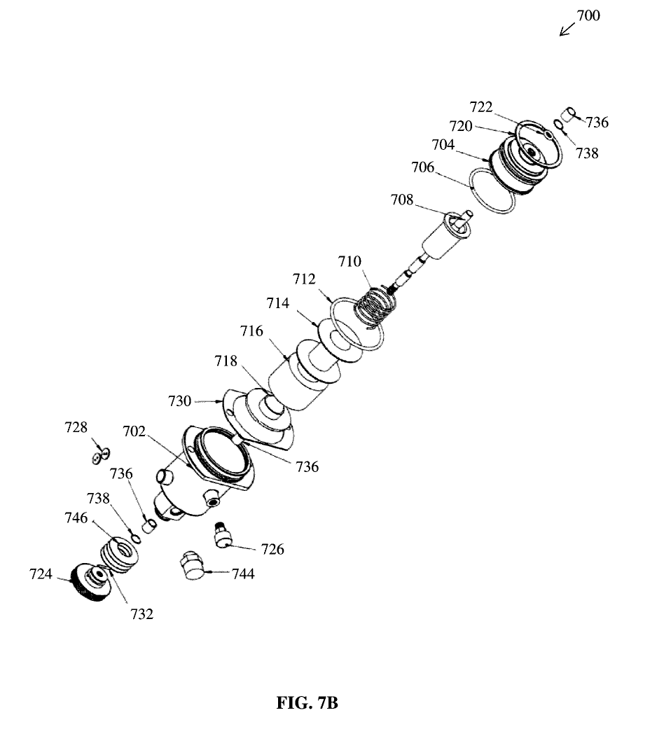

FIG. 3 illustrates an a cutaway, side view of a 3D rendering of an exemplary electrically-actuated solenoid for an air intake shut-off valve according to the embodiment of the present invention; and FIG. 7A illustrates an exploded, side view of the exemplary electrically-actuated solenoid shown in FIG. 3. As shown in FIGS. 3 & 7A, the solenoid assembly 300, 700 comprises a solenoid housing 302, 702, a retainer plug 304, 704, a trip rod assembly 308, 708, a coil core 314, 714, a coil 316, 716, a retainer ring 320, 720, a manual trip handle 324, 724, a breather vent 326, 726 and a limit switch 344, 744. (Cf. FIGS. 7A & 7B). In an embodiment, the solenoid 300, 700 is in the normally closed position. Id.

In an embodiment, the solenoid housing 302, 702 may be made of any suitable material. Suitable materials include, but are not limited to, metals, plastics and combinations thereof. In an embodiment, the solenoid housing 302, 702 may be made of molded plastic or cast aluminum. In an embodiment, the solenoid housing 302, 702 is made of cast aluminum.

In an embodiment, the trip rod assembly 308, 708 has a first end and a second end. In an embodiment, the first end of the trip rod assembly 308, 708 extends through the valve housing 202 and engages the “L” shaped notch in the first end of the pivot shaft 202 to hold the air intake shut-off valve 200 in the open position (see e.g., FIG. 2) and disengages the “L” shaped notch in the first end of the pivot shaft 104 to switch the valve 100 to the closed position (see e.g., FIG. 1).

In an embodiment, a manual trip handle 324, 724 is attached to the second end of the trip rod assembly 308, 708. In an embodiment, the trip rod assembly 308, 708 disengages from the “L” shaped notch in the first end of the pivot shaft 102 when the manual trip handle 324, 724 is withdrawn from the solenoid from a first position to a second position, closing the air intake shut-off valve 100. (See e.g., FIG. 1).

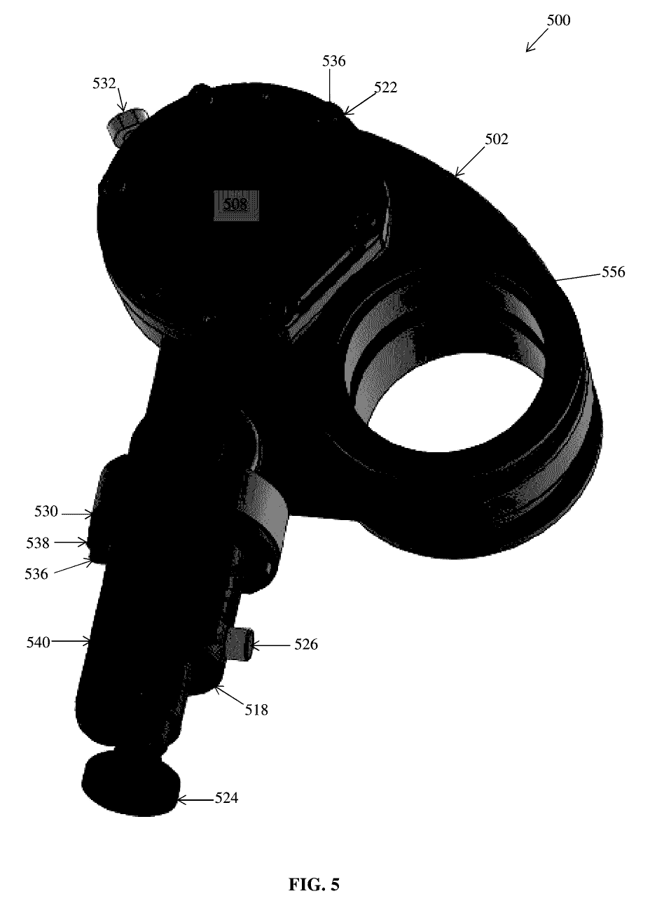

FIG. 4A illustrates a top view of a 3D rendering of an air intake shut-off valve in a closed position according to an embodiment of the present invention; FIG. 4B illustrates a bottom view of a 3D rendering of the air intake shut-off valve shown in FIG. 4A; FIG. 5 illustrates an isometric view of a 3D rendering of an air intake shut-off valve in an open position according to an embodiment of the present invention; and FIG. 6 illustrates an exploded, side view of the air intake shut-off valve shown in FIGS. 4A-4B and 5. As shown in FIGS. 4A-4B & 5, the air intake shut-off valve 400, 500 comprises a valve housing 402, 502, a pivot shaft spring retainer 406, a service port cover 408, 508, a trip spring 410, a shaft spring-rod connector 414, a valve disk 416, a solenoid assembly 418, 518, a first screw 420, a first washer 422, 522, a manual trip handle 424, 524, a breather vent 426, 526, a solenoid insulator 430, 530, a spring guide rod 432, 532, a second screw 436, 536, a reset handle 440, 540, a limit switch 444, an air inlet 454 and an air outlet 456, 556. In an embodiment, the air intake shut-off valve 400, 600 is in the normally open position and the solenoid 418, 618 is in the normally closed position. In an embodiment, the solenoid 418, 618 may be electrically, pneumatically or hydraulically operated.

As shown in FIGS. 4B & 6, the valve disk 416 may be installed through a service port in the valve housing 402, 602 and attached to the pivot shaft 604. The pivot shaft 604 may be installed through an attachment flange in the solenoid housing 702. In operation, the service port in the valve housing 402, 602 is sealed with a service port cover 408, 608. In an embodiment, the service port cover 408, 608 may be made of any suitable material capable of withstanding temperatures between about −4° F. and about 500° F. (and any range or value there between) and pressures up to about 75 psi (and any range or value there between). Suitable materials include, but are not limited to, metals, plastics and combinations thereof. In an embodiment, the service port cover 408, 608 may be made of molded plastic or cast aluminum. In an embodiment, the service port cover 408, 608 is made of cast aluminum.

In an embodiment, the service port cover 408, 608 is attached to the valve housing 402, 602 with fasteners 436, 636. (See e.g., FIGS. 4B & 6). In an embodiment, the fasteners 436, 636 may be any suitable fastener. Suitable fasteners include, but are not limited to bolts, screws and combinations thereof. Fasteners are well known in the art.

In an embodiment, the fasteners 436, 636 may be used in combination with washers 438, 638. Any suitable washer may be used. Suitable washers include, but are not limited to, flat washers, lock washers and combinations thereof. Washers are well known in the art.

In an embodiment, the service port cover 408, 608 seals against the valve housing 402, 602 with a gasket or an O-ring 650. (See e.g., FIGS. 4B & 6). Gaskets and O-rings are well known in the art. In an embodiment, the gasket and/or O-rings 650 may be made of any suitable material capable of withstanding temperatures between about −4° F. and about 500° F. (and any range or value there between) and pressures up to about 75 psi (and any range or value there between). Suitable materials include, but are not limited to, plastics, rubber and combinations thereof. In an embodiment, the gasket 650 may be made of a polyimide (PI) (i.e., Kapton®) or a polytetrafluroethylene (PTFE) (i.e., Teflon™). In an embodiment, the O-rings 650 may be made of rubber.

In an embodiment, the solenoid assembly 418, 618 is attached to the valve housing 402, 602 with fasteners 436, 636. (See e.g., FIGS. 4A-4B, 6-7B). In an embodiment, the fasteners 436, 636 may be any suitable fastener. Suitable fasteners include, but are not limited to bolts, screws and combinations thereof. Fasteners are well known in the art.

In an embodiment, the fasteners 436, 636 may be used in combination with washers 438, 638. In an embodiment, any suitable washer 438, 638 may be used. Suitable washers include, but are not limited to, flat washers, lock washers and combinations thereof. Washers are well known in the art.

In an embodiment, the solenoid 418, 618 seals against the valve housing 402 with a gasket or an O-ring. (See e.g., FIGS. 4A-4B & 6). Gaskets and O-rings are well known in the art.

In an embodiment, the gasket and/or O-ring may be made of any suitable material. Suitable materials include, but are not limited to, plastics, rubber and combinations thereof. In an embodiment, the gasket may be made of a polyimide (PI) (i.e., Kapton®) or a polytetrafluroethylene (PTFE) (i.e., Teflon™). In an embodiment, the O-ring may be made of rubber.

In an embodiment, the solenoid insulator 430, 730 may be disposed between the valve housing 402, 602 and solenoid 418, 618 to reduce the heat transfer to the solenoid 418, 618. (See e.g., FIGS. 4A-4B & 6-7B). In an embodiment, the solenoid insulator 430, 730 may be made of any suitable insulating material. Suitable insulating materials include, but are not limited to, laminates, plastics and combinations thereof. In an embodiment, the solenoid insulator 430, 730 may be made of a carbon-filled polyether ether ketone (PEEK) or a polyetherimide (PEI) (i.e., Ultem™). In an embodiment, the solenoid insulator 430, 730 may be made of a G10 Glass reinforced epoxy laminate.

In an embodiment, the reset handle 440, 540 is attached to the first end of the actuator shaft 112, 212. In an embodiment, the reset handle 440, 540 rotates the actuator shaft from the second position to the first position, opening the air intake shut-off valve 400, 500. (See e.g., FIGS. 4B & 5). In an embodiment, the reset handle 440, 540 rotates the actuator shaft clockwise from the second position to the first position, opening the air intake shut-off valve 400, 500.

In an embodiment, the reset handle 440, 540 rotates from about 40 degrees to about 80 degrees from the second position to the first position (and any range or value there between). In an embodiment, reset handle 440, 540 rotates from about 60 degrees to about 70 degrees from the second position to the first position (and any range or value there between). In an embodiment, the reset handle 440, 540 rotates from about 65 degrees from the second position to the first position.

FIG. 6 illustrates an exploded, side view of an air intake shut-off valve shown in FIGS. 4A-4B and 5. As shown in FIG. 6, the air intake shut-off valve 600 comprises a valve housing 602, a pivot shaft 604, a pivot shaft spring retainer 606, a service port cover 608, a trip spring 610, an actuator shaft 612, a shaft spring-rod connector 614, a valve disk 616, a solenoid assembly 618 (see e.g., FIGS. 7A & 7B), a first screw 620, a first washer 622, an insulating washer 624, a clevis 626, a Woodruff key 628, a spring guide threaded arm 630, a retainer ring 634, a second screw 636, a second washer 638, a handle 640, a third screw 642, a third washer 644, a cable mount 646, a first gasket or O-ring 648, a second gasket or O-ring 650, and a third gasket or O-ring 652. (See e.g., FIGS. 1-2).

In an embodiment, the pivot shaft spring retainer 606 may be made of any suitable material. Suitable materials include, but are not limited to, aluminum, steel, stainless steel and combination thereof. In an embodiment, the pivot shaft spring retainer 606 is made of aluminum.

In an embodiment, the trip spring 610 may be made of any suitable material. Suitable materials include, but are not limited to, metals, stainless steel and combinations thereof. In an embodiment, the trip spring 610 is made of nickel-chromium-steel alloy (i.e., Inconel®).

In an embodiment, the shaft spring-rod connector 614 may be made of any suitable material. Suitable materials include, but are not limited to, metals, stainless steel and combinations thereof. In an embodiment, the shaft spring-rod connector 614 is made of stainless steel.

In an embodiment, the first screw 620, the second screw 636, and the third screw 642 may be any suitable fastener. Suitable fasteners include, but are not limited to, bolts, screws and combinations thereof. In an embodiment, the first screw 620 is a socket head cap screw 0.312-18×0.750 inch. In an embodiment, the second screw 636 is a modified socket head cap screw 5/16-18×¾ inch. In an embodiment, the third screw 642 is a socket head cap screw 0.312-18×0.50 inch. Fasteners are well known in the art.

In an embodiment, the first washer 622, the second washer 638, and the third washer 644 may be any suitable washer. Suitable washers include, but are not limited to, flat washers, lock washers and combinations thereof. In an embodiment, the first washer 622 is a flat washer 0.312. In an embodiment, the second washer 638 is a flat washer 0.312. Washers are well known in the art.

In an embodiment, the insulating washer 624 may be any suitable insulating washer. In an embodiment, the insulating washer 624 is a red insulating hard fiber washer 1/32 inches thick×¾ inches inner diameter×1 inch.

In an embodiment, the actuator shaft 612 seals against valve housing 602 with the first gasket or O-ring 648, the service port cover 608 seals against the valve housing 602 with the second gasket or O-ring 650, and the pivot shaft spring retainer 606 seals against the valve housing 602 with the third gasket or O-ring 652. Gaskets and O-rings are well known in the art.

In an embodiment, the gasket and/or O-rings 648, 650, 652 may be made of any suitable material capable of withstanding temperatures between about −4° F. and about 500° F. (and any range or value there between) and pressures up to about 75 psi (and any range or value there between). Suitable materials include, but are not limited to, plastics, rubber and combinations thereof. In an embodiment, the gasket 648, 650, 652 may be made of a polyimide (PI) (i.e., Kapton®) or a polytetrafluroethylene (PTFE) (i.e., Teflon™). In an embodiment, the O-rings 648, 650, 652 may be made of rubber.

In an embodiment, the clevis 626 may be made of any suitable material. Suitable materials include, but are not limited to, metals, stainless steel and combinations thereof. In an embodiment, the clevis 626 is made of stainless steel. In an embodiment, the clevis 626 is a stainless steel grooved clevis with E.R. ¼ inch×¾ inch OAL.

In an embodiment, the Woodruff key 628 may be made of any suitable material. Suitable materials include, but are not limited to, metals, steel, stainless steel and combinations thereof. In an embodiment, the Woodruff key 628 is made of steel.

In an embodiment, the spring guide threaded arm 630 may be made of any suitable material. Suitable materials include, but are not limited to, metals, steel, stainless steel and combinations thereof. In an embodiment, the spring guide threaded arm 630 is made of stainless steel.

In an embodiment, the retainer ring 634 may be made of any suitable material. Suitable materials include, but are not limited to, metals, stainless steel and combinations thereof. In an embodiment, the retainer ring 634 is made of stainless steel. In an embodiment, the retainer ring 634 is a spiral external retaining ring ¾ inch shaft.

In an embodiment, the handle 640 may be made of any suitable material. Suitable materials include, but are not limited to, metals, plastics and combinations thereof. In an embodiment, the handle 640 is made of aluminum.

### Solenoid Assembly

As discussed above, the solenoid 118, 218 may be any suitable solenoid having a trip rod assembly. Suitable solenoids include, but are not limited to, electrically-actuated solenoids, pneumatically-actuated solenoids and hydraulically-actuated solenoids. Solenoids are well known in the art.

FIG. 3 illustrates a cutaway, side view of a 3D rendering of an exemplary electrically-actuated solenoid for an air intake shut-off valve according to the embodiment of the present invention; and FIG. 7A illustrates an exploded, side view of the exemplary electrically-actuated solenoid shown in FIG. 3. As shown in FIGS. 3 and 7A, the solenoid 300, 700 comprises a solenoid housing 302, 702, a retainer plug 304, 704, a trip rod assembly 308, 708, a solenoid spring 310, 710, a coil core 314, 714, a coil 316, 716 and an end plug 318, 718. (Cf. FIGS. 7A & 7B). In an embodiment, the solenoid 300 is in the normally closed position. Id. In an embodiment, the solenoid 300 may be electrically, pneumatically or hydraulically operated.

In an embodiment, the solenoid housing 302, 702 may be made of any suitable material capable of withstanding temperatures between about −4° F. and about 500° F. (and any range or value there between). Suitable materials include, but are not limited to, metals, plastics and combinations thereof. In an embodiment, the solenoid housing 302, 702 may be made of molded plastic or cast aluminum. In an embodiment, the solenoid housing 302, 702 is made of cast aluminum.

In an embodiment, the retainer plug 304, 704 may be made of any suitable material. Suitable materials include, but are not limited to, metals, plastics and combinations thereof. In an embodiment, the retainer plug 304, 704 is made of aluminum.

In an embodiment, the trip rod assembly 308, 708 may be made of any suitable material. Suitable materials include, but are not limited to, metals, plastics and combinations thereof. In an embodiment, the trip rod assembly 308, 708 is made of metals, steel, stainless steel and combinations thereof.

In an embodiment, the solenoid spring 310, 710 may be made of any suitable material. Suitable materials include, but are not limited to, metals, stainless steel and combinations thereof. In an embodiment, the solenoid spring 310, 710 is made of nickel-chromium-steel alloy (i.e., Inconel®).

In an embodiment, the coil core 314, 714 may be made of any suitable material. Suitable materials include, but are not limited to, steel and combinations thereof. In an embodiment, the coil core 314, 714 is made of steel.

In an embodiment, the coil 316, 716 may be made of any suitable material. Suitable materials include, but are not limited to, magnetic wire. In an embodiment, the coil 316, 716 is made of magnetic wire.

FIG. 7A illustrates an exploded, side view of a solenoid for an air intake shut-off valve according to an embodiment of the present invention. As shown in FIG. 7A, the solenoid 700 comprises a solenoid housing 702, a retainer plug 704, a first gasket or O-ring 706, a trip rod assembly 708, a solenoid spring 710, a second gasket or O-ring 712, a coil core 714, a coil 716, an end plug 718, a retainer ring 720, a third gasket or O-ring 722, a manual trip handle 724, a breather vent 726, a potting gasket 728, a solenoid insulator 730, a slotted spring pin 732, a solenoid bushing 734, a bushing 736, an internal retainer ring 738, a fourth gasket or O-ring 740, a fifth gasket or O-ring 742 and a limit switch 744. (See e.g., FIGS. 3 & 7B).

In an embodiment, the retainer plug 704 seals against the solenoid housing 702 with the first gasket or O-ring 706, the end plug 718 seals against the solenoid housing 702 with the second gasket or O-ring 712, the retainer plug 704 seals against the valve housing 602 (see FIG. 6) with third gasket or O-ring 722, the trip rod assembly 704 seals against the solenoid housing 702 with a sealing assembly comprising solenoid bushing 734, fourth gasket or O-ring 740 and fifth gasket or O-ring 742. (See e.g., FIG. 7A). Gaskets and O-rings are well known in the art.

In an alternative embodiment, the retainer plug 704 seals against the solenoid housing 702 with the first gasket or O-ring 706, the end plug 718 seals against the solenoid housing 702 with the second gasket or O-ring 712, the retainer plug 704 seals against the valve housing 602 (see FIG. 6) with third gasket or O-ring 722, the trip rod assembly 704 seals against the solenoid housing 702 with a bellows seal 746. (See e.g., FIG. 7B). In this embodiment, the bellows seal 746 replaces the sealing assembly comprising solenoid bushing 734, fourth gasket or O-ring 740 and fifth gasket or O-ring 742. (Cf. FIGS. 7A & 7B). Bellows seals are well known in the art.

In an embodiment, the gasket and/or O-rings 706, 712, 722, 740, 742 may be made of any suitable material capable of withstanding temperatures between about −4° F. and about 500° F. (and any range or value there between) and pressures up to about 75 psi (and any range or value there between). Suitable materials include, but are not limited to, plastics, rubber and combinations thereof. In an embodiment, the gasket 706, 712, 722, 740, 742 may be made of a polyimide (PI) (i.e., Kapton®) or a polytetrafluroethylene (PTFE) (i.e., Teflon™). In an embodiment, the O-rings 706, 712, 722, 740, 742 may be made of rubber. In an embodiment, the O-rings 706, 722 are S-70.

In an embodiment, the bellows seal 746 may be any suitable bellows seal.

In an embodiment, the solenoid spring 710 may be made of any suitable material. Suitable materials include, but are not limited to, metals, stainless steel and combinations thereof. In an embodiment, the solenoid spring 710 is made of a nickel-chromium-steel alloy (i.e., Inconel®).

In an embodiment, the end plug 718 may be any suitable end plug.

In an embodiment, the retainer ring 720 and the internal retainer ring 738 may be any suitable retainer ring. In an embodiment, the retainer ring 720 is a Spiralok #WHM-250 retainer ring. In an embodiment, the internal retainer ring 738 is a spiral internal retainer ring ¾ inch diameter.

In an embodiment, the manual trip handle 724 may be any suitable handle or knob. In an embodiment, the manual trip handle 724 is a 2 inch threaded knob.

In an embodiment, the breather vent 726 may be any suitable breather vent. In an embodiment, the breather vent 726 is a hooded breather vent.

In an embodiment, the potting gasket 728 may be any suitable potting gasket.

In an embodiment, the solenoid insulator 730 may be disposed between the valve housing 102, 202 and solenoid 118, 218 to reduce the heat transfer to the solenoid 118, 218. (See e.g., FIGS. 7A & 7B). In an embodiment, the solenoid insulator 730 may be made of any suitable insulating material. Suitable insulating materials include, but are not limited to, laminates, plastics and combinations thereof. In an embodiment, the solenoid insulator 730 may be made of a carbon-filled polyether ether ketone (PEEK) or a polyetherimide (PEI) (i.e., Ultem™). In an embodiment, the solenoid insulator 730 may be made of a G10 Glass reinforced epoxy laminate.

In an embodiment, the slotted spring pin 732 may be any suitable slotted spring pin. In an embodiment, the slotted spring pin 732 is an 18-8 stainless steel slotted spring pin.

In an embodiment, the solenoid bushing 734 and the bushing 736 may be any suitable bushing. In an embodiment the bushing 736 is a 15/32 inch outer diameter×⅜ inch inner diameter×½ inch OAL.

In an embodiment, the limit switch 744 may be any suitable limit switch. In an embodiment, the limit switch 744 is a sealed, normally closed limit switch with a stainless steel ball plunger.

### Air Intake Shut-Off Valve Assembly (Cont.)

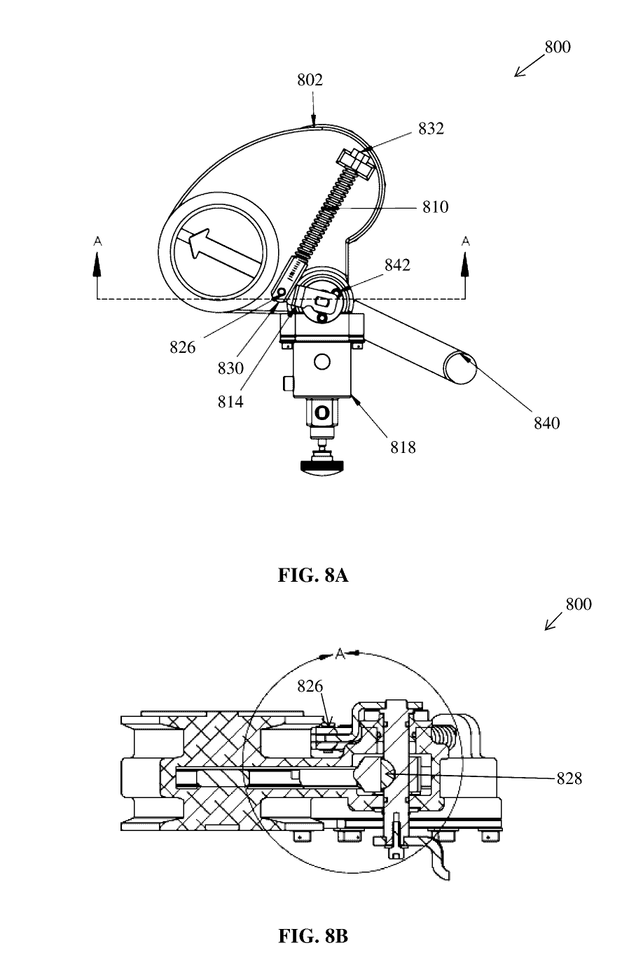

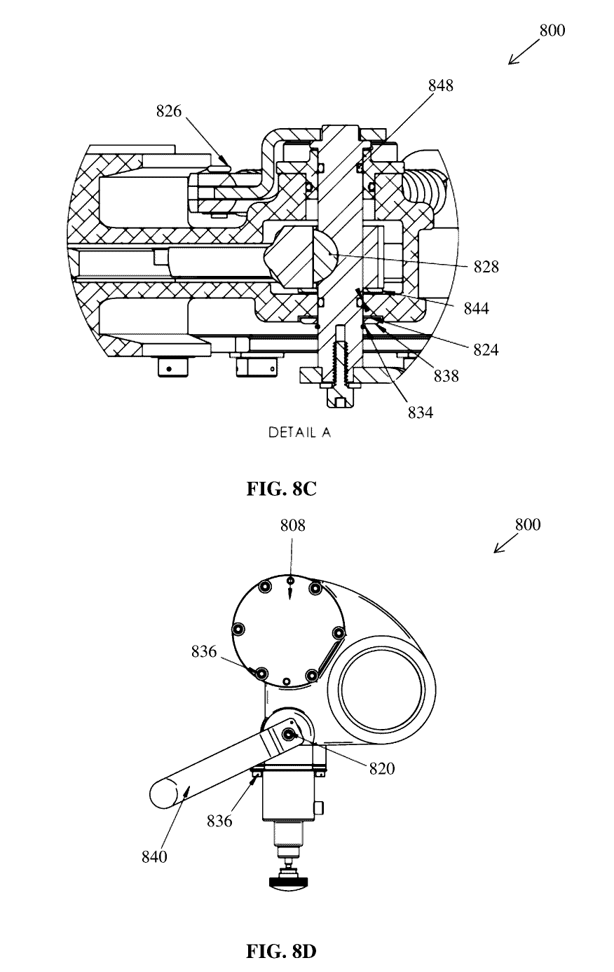

FIG. 8A is a top view of an air intake shut-off valve in a closed position according to an embodiment of the present invention; FIG. 8B is a cross-sectional, A-A side view of the air intake shut-off valve shown in FIG. 8A; FIG. 8C is a detailed, cross-sectional, A-A side view of the air intake shut-off valve shown in FIG. 8B; and FIG. 8D is an illustration of a bottom view of the air intake shut-off valve shown in FIG. 8A. As shown in FIGS. 8A and 8D, the air intake shut-off valve 800 comprises a valve housing 802, a service port cover 808, a trip spring 810, a shaft spring-rod connector 814, a solenoid assembly 818, a first screw 820, a clevis 826, a spring guided threaded arm 830, a spring guide rod 832, a second screw 836, a handle 840 and a third screw 842. (See e.g., FIGS. 1-2 & 6). As shown in FIGS. 8A and 8B, the air intake shut-off valve 800 comprises a first washer 822, a solenoid insulator 824 (see e.g., FIGS. 7A & 7B), a clevis 826, a Woodruff key 828, a retaining ring 834, a second washer 838, a third washer 844, and a first O-ring 848.

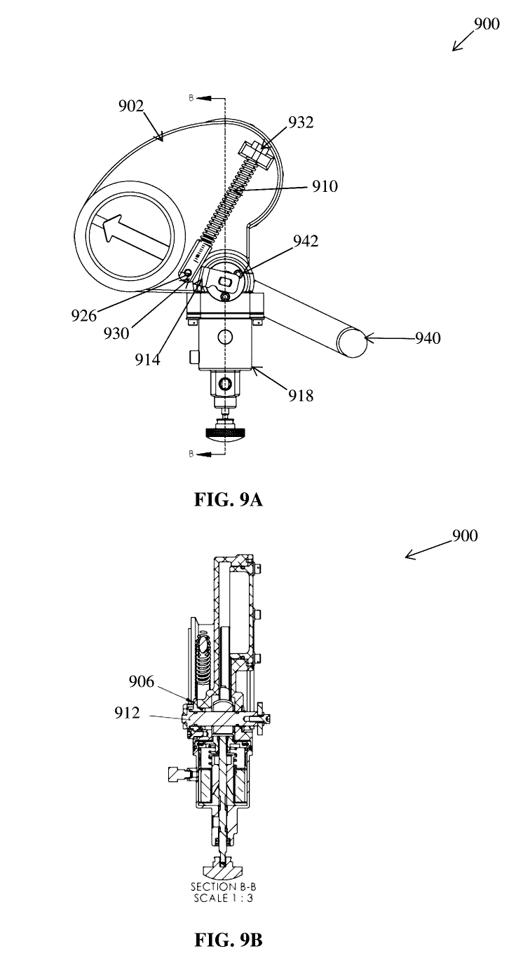

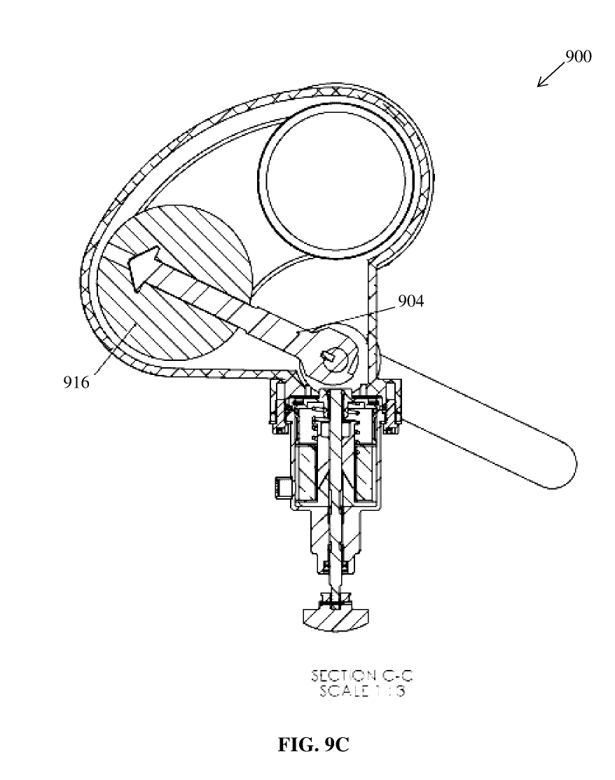

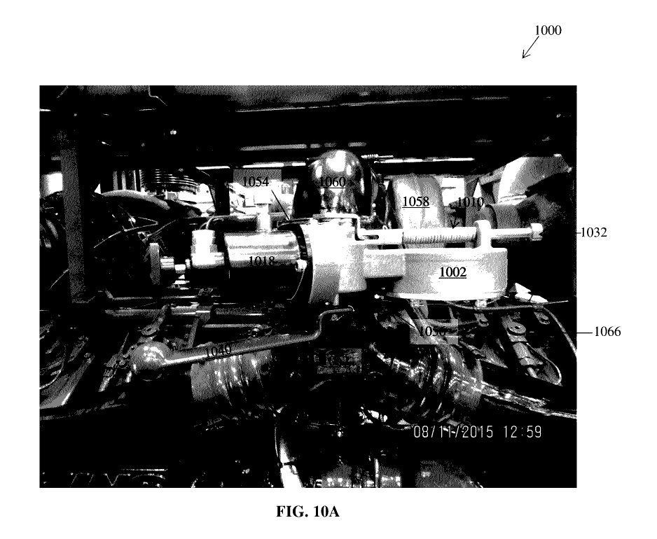

FIG. 9A is a top view of an air intake shut-off valve according to an embodiment of the present invention; FIG. 9B is a cross-sectional, B-B side view of the air intake shut-off valve shown in FIG. 9A; and FIG. 9C is a cross-sectional, top view of the air intake shut-off valve shown in FIG. 9A. As shown in FIGS. 9A and 9C, the air intake shut-off valve 900 comprises a valve housing 902, a pivot shaft 904, a trip spring 910, a shaft spring-rod connector 914, a valve disk 916, a solenoid assembly 918 (see e.g., FIGS. 3 & 7A-7B), a clevis 926, a spring guide threaded arm 930, a spring guide rod 932, a reset handle 940, and a fastener 942. (See e.g., FIGS. 1-2 & 6). As shown in FIG. 9B, the air intake shut-off valve 900 comprises a pivot shaft spring retainer 906 and an actuator shaft 912.

### Operation of Air Intake Shut-Off Valve Assembly

The air intake shut-off valve 400, 600 is designed to enable an operator or a computing device 1300 (discussed below) to stop the air flow to an engine or machine at any time the engine is not controllable by normal fuel metering or shut-off methods.

The air intake shut-off valve 400, 600 may be activated by an electrical signal from the operator or the computing device 1300 (e.g., engine computer control system). The electronic signal switches the solenoid 418, 618 (see e.g., FIGS. 4A-4B & 6) from a normally closed position to an open position, which switches the air intake shut-off valve 400, 600 from a normally open position to a closed position to block air flow to the engine or machine. In an embodiment, the solenoid 418, 618 may be an electrically-actuated solenoid, a pneumatically-actuated solenoid or a hydraulically-actuated solenoid, each having a trip rod assembly. In an embodiment, the air intake shut-off valve 400, 600 may be manually activated by an operator pulling the reset handle 440, 640.

In an embodiment, the trip rod assembly 708 is attached to an electric plunger assembly in an electrically-actuated solenoid 300, 700, an air plunger assembly in a pneumatically-actuated solenoid or a hydraulic plunger in a hydraulically-actuated solenoid. Solenoids are well known in the art.

For example, when the electrically-actuated solenoid 300, 700 is activated, the trip rod assembly 708 is withdrawn to release the spring-loaded pivot shaft 604 attached to the valve disk 416, 616 and the spring-loaded pivot shaft 604 rotates the disk cover 416, 616 to stop the air flow to the engine or machine. In an embodiment, the withdrawal of the trip rod assembly 708 to activate the spring-loaded pivot shaft 604 also activates the limit switch 344, 744.

### Method of Using Air Intake Shut-Off Valve

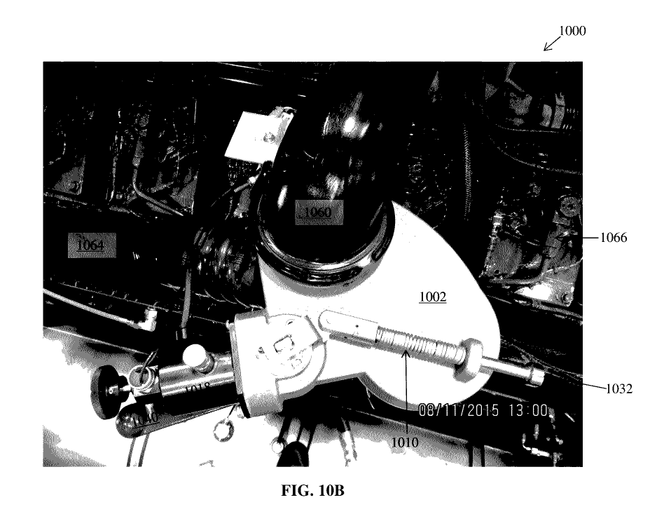

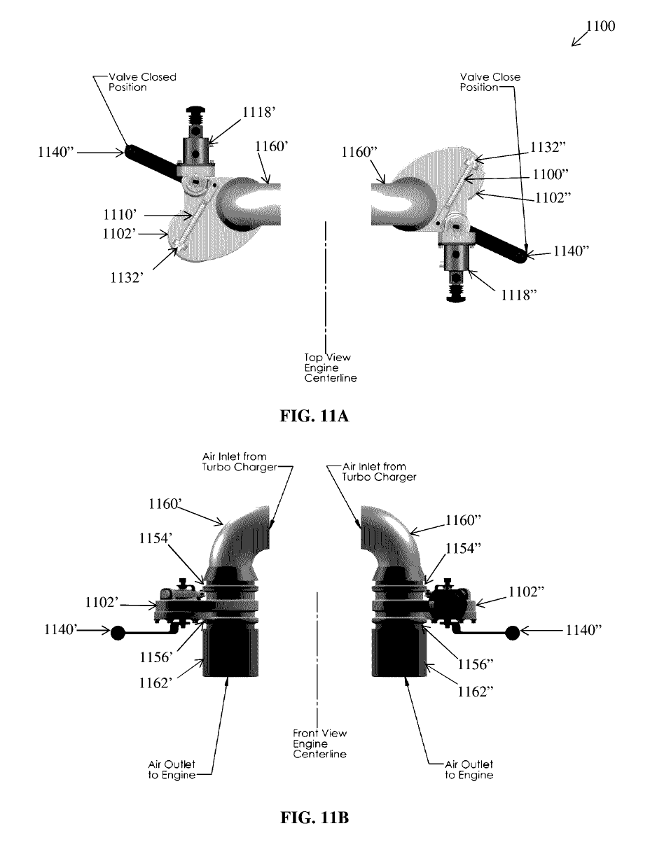

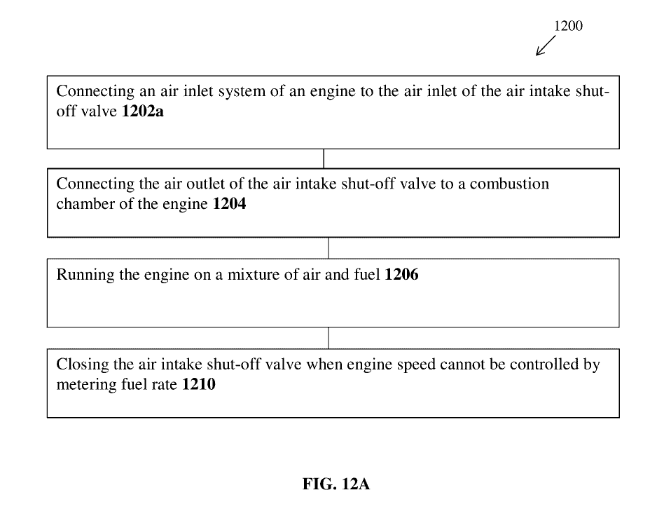

FIGS. 10-11 illustrates a method of using an air intake shut-off valve according to an embodiment of the present invention. FIG. 10A is a side view of an air intake shut-off valve according to an embodiment of the present invention as installed on an exemplary diesel engine with a turbocharger; and FIG. 10B is a top view of the air intake shut-off valve shown in FIG. 10A. As shown in FIGS. 10A and 10B, the air intake shut-off system 1000 comprises a valve housing 1002, a trip spring 1010, a solenoid assembly 1018, a spring guide arm 1032, a reset handle 1040, an air inlet 1054 (e.g., from turbocharger 1058), an air outlet 1056 (e.g., to charge-air cooler system 1064), an air inlet pipe 1060 (e.g., from turbocharger 1058), an air outlet pipe 1062 (e.g., to charge-air cooler system 1064) and an engine or machine 1066.

FIG. 11A is a top view of a 3D rendering of a pair of air intake shut-off valves as installed on an exemplary diesel engine with dual turbochargers, wherein an air inlet from the turbochargers and an air outlet to the engine are shown; and FIG. 11B is a front view of a 3D rendering of the pair of air intake shut-off valves shown in FIG. 11A. As shown in FIGS. 11A and 11B, a duel air intake shut-off system 1100 comprises a pair of air intake shut-off valves 1100′, 1100″ having valve housings 1102′, 1102″, trip springs 1110′, 1110″, solenoid assemblies 1118′, 1118″, spring guide rods 1132′, 1132″, reset handles 1140′, 1140″, air inlets 1154′,1154″ and air outlets 1156′, 1156″, a pair of inlet pipes 1160′, 1160″ from the exemplary turbochargers (i.e., dual air intakes), a pair of outlet pipes 1162′, 1162″ to the exemplary diesel engine or machine (not shown).

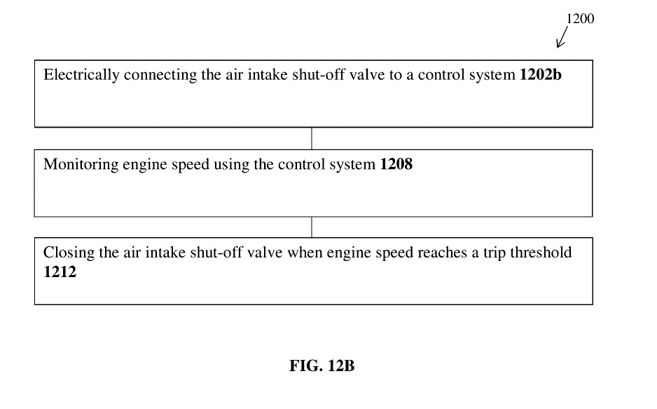

As shown in FIGS. 10-11, the method of using the air intake shut-off 1200 comprises the steps: fluidly connecting an air inlet system of an engine or a machine to the air inlet of the air intake shut-off valve 1202a, fluidly connecting the air outlet of the air intake shut-off valve to a combustion chamber of the engine or the machine 1204, running the engine or the machine on a mixture of air and fuel 1206, and closing the air intake shut-off valve when engine speed cannot be controlled by metering fuel rate or using other engine shut-off methods 1210. (See e.g., FIG. 12A).

In an embodiment, the method further comprises the steps of electrically connecting the air intake shut-off valve to a control system 1202b, monitoring engine speed using the control system 1208, and closing the air intake shut-off valve when the engine speed reaches a trip threshold 1212. (See e.g., FIG. 12B).

In an embodiment, the trip threshold is from about 2400 rpm to about 7000 rpm (and any range or value there between). In an embodiment, the trip threshold is from about 2400 rpm to about 5500 rpm (and any range or value there between). In an embodiment, the trip threshold is about 2500 rpm.

### Computing Device

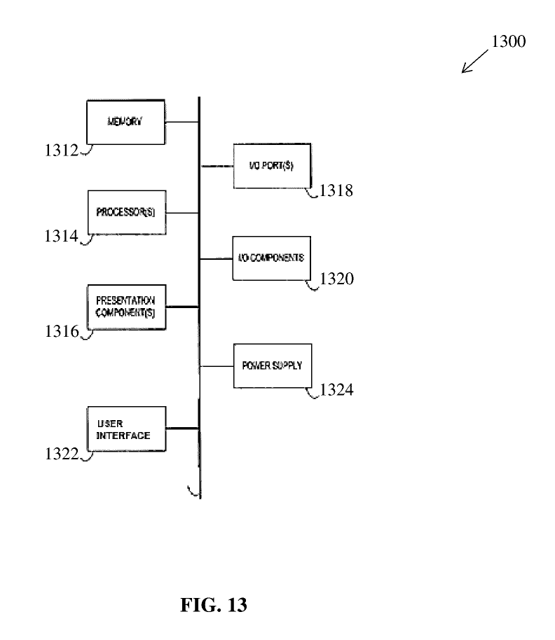

FIG. 13 illustrates an exemplary computing device for the method of using the air intake shut-off valve, discussed above. As shown in FIGS. 12B and 13, the method further comprises a computing device 1300. The computing device 1300 may be any suitable computing device. For example, a suitable computing device includes, but is not limited to, a computer, an engineered circuit board(s) and a programmable logic controller. Suitable computing devices are well known in the art.

With reference to FIG. 13, the computing device 1300 of the method 1200 may include a bus 1310 that directly or indirectly couples the following devices: memory 1312, one or more processors 1314, one or more presentation components 1316, one or more input/output (I/O) ports 1318, I/O components 1320, a user interface 1322 and an illustrative power supply 1324. In an embodiment, the air inlet shut-off valve(s) (e.g., solenoid(s) 1018) and the engine(s) 1064 (e.g., tachometer(s)) may couple directly or indirectly to a signal conditioning device. If the component's raw signal must be processed to provide a suitable signal for an I/O system, that component will couple indirectly the signal conditioning device.

The bus 1310 represents what may be one or more busses (such as an address bus, data bus, or combination thereof). Although the various blocks of FIG. 13 are shown with lines for the sake of clarity, in reality, delineating various components is not so clear, and metaphorically, the lines would more accurately be fuzzy. For example, one may consider a presentation component such as a display device to be an I/O component. Additionally, many processors have memory. The inventors recognize that such is the nature of the art, and reiterate that the diagram of FIG. 13 is merely illustrative of an exemplary computing device that can be used in connection with one or more embodiments of the present invention. Further, a distinction is not made between such categories as “workstation,” “server,” “laptop,” “mobile device,” etc., as all are contemplated within the scope of FIG. 13 and references to “computing device.”

The computing device 1300 of the method 1200 typically includes a variety of computer-readable media. Computer-readable media can be any available media that can be accessed by the computing device 1300 and includes both volatile and nonvolatile media, removable and non-removable media. By way of example, and not limitation, computer-readable media may comprise computer-storage media and communication media. The computer-storage media includes volatile and nonvolatile, removable and non-removable media implemented in any method or technology for storage of information such as computer-readable instructions, data structures, program modules or other data. Computer-storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 1300.

The memory 1312 includes computer-storage media in the form of volatile and/or nonvolatile memory. The memory 1312 may be removable, non-removable, or a combination thereof. Suitable hardware devices include solid-state memory, hard drives, optical-disc drives, etc. The computing device 1300 includes one or more processors 1314 that read data from various entities such as the memory 1312 or the I/O components 1320.

The presentation component(s) 1316 present data indications to a user or other device. In an embodiment, the computing device 1300 outputs present data indications including, for example, air intake shut-off valve(s) status, engine(s) speed, and/or the like to a presentation component 1316. Suitable presentation components 1316 include a display device, speaker, printing component, vibrating component, and the like.

The user interface 1322 allows the user to input/output information to/from the computing device 1300. Suitable user interfaces 1322 include keyboards, key pads, touch pads, graphical touch screens, and the like. In some embodiments, the user interface 1322 may be combined with the presentation component 1316, such as a display and a graphical touch screen. In some embodiments, the user interface 1322 may be a portable hand-held device. The use of such devices is well known in the art.

The one or more I/O ports 1318 allow the computing device 1300 to be logically coupled to other devices including the air intake shut-off valve(s) (e.g., solenoid(s) 1018), the engine(s) 1064 (e.g., tachometer(s)), and other I/O components 1320, some of which may be built-in. Examples of other I/O components 1320 include a printer, scanner, wireless device, and the like.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms (e.g., “outer” and “inner,” “upper” and “lower,” “first” and “second,” “internal” and “external,” “above” and “below” and the like) are used as words of convenience to provide reference points and, as such, are not to be construed as limiting terms.

The embodiments set forth herein are presented to best explain the present invention and its practical application and to thereby enable those skilled in the art to make and utilize the invention. However, those skilled in the art will recognize that the foregoing description has been presented for the purpose of illustration and example only. The description as set forth is not intended to be exhaustive or to limit the invention to the precise form disclosed. Many modifications and variations are possible in light of the above teaching without departing from the spirit and scope of the following claims. The invention is specifically intended to be as broad as the claims below and their equivalents.

Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

### DEFINITIONS

As used herein, the terms “a,” “an,” “the,” and “said” mean one or more, unless the context dictates otherwise.

As used herein, the term “about” means the stated value plus or minus a margin of error or plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more element(s) recited after the term, where the element or elements listed after the transition term are not necessarily the only elements that make up the subject.

As used herein, the terms “containing,” “contains,” and “contain” have the same open-ended meaning as “comprising,” “comprises,” and “comprise” provided above.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

As used herein, the phrase “consisting of” is a closed transition term used to transition from a subject recited before the term to one or more material element(s) recited after the term, where the material element or elements listed after the transition term are the only material element(s) that make up the subject.

As used herein, the term “simultaneously” means occurring at the same time or about the same time, including concurrently.

### INCORPORATION BY REFERENCE

All patents and patent applications, articles, reports, and other documents cited herein are fully incorporated by reference to the extent they are not inconsistent with this invention.

What is claimed is:

1. An air intake shut-off valve, comprising:
a) a seamless valve housing having an air inlet and an air outlet;
b) a pivot shaft having a first end and a second end, wherein the pivot shaft is disposed within the valve housing, wherein the pivot shaft has an “L” shaped notch in the first end and wherein the pivot shaft rotates about an actuator shaft from a first position to a second position;
c) a solenoid having a trip rod assembly having a first end and a second end, wherein the solenoid is attached to the valve housing, wherein the first end of the trip rod assembly extends through the valve housing and engages the “L” shaped notch in the first position and wherein the first end of the trip rod assembly disengages from the “L” shaped notch in the second position;
d) a valve disk attached to the second end of the pivot shaft, wherein the valve disk covers the air outlet in the second position, wherein the valve housing has a service port adjacent to the valve disk in the first position and wherein a service port cover is attached to the valve housing.

2. The air intake shut-off valve of claim 1, wherein a reset handle is attached to the first end of the actuator shaft, and wherein the reset handle rotates the actuator shaft from the second position to the first position.

3. The air intake shut-off valve of claim 2, wherein the reset handle rotates from about 60 degrees to about 70 degrees to switch the pivot shaft from the second position to the first position.

4. The air intake shut-off valve of claim 1, wherein a manual trip handle is attached to the second end of the trip rod assembly, wherein the trip rod assembly disengages from the “L” shaped notch when the manual trip handle is withdrawn.

5. The air intake shut-off valve of claim 1, wherein the valve housing is made of the group consisting of metals, plastics and combinations thereof.

6. The air intake shut-off valve of claim 5, wherein the valve housing is made of cast aluminum or molded plastic.

7. The air intake shut-off valve of claim 1, wherein the valve disk is made of the group consisting of metals, plastics and combinations thereof.

8. The air intake shut-off valve of claim 7, wherein the valve disk is made of a carbon-filled polyether ether ketone (PEEK) or a polyetherimide (PEI).

9. The air intake shut-off valve of claim 7, wherein the valve disk is made of a carbon-filled polyether ether ketone (PEEK).

10. The air intake shut-off valve of claim 1, wherein a solenoid insulator is disposed between the solenoid and the valve housing, wherein the solenoid insulator is made of the group consisting of laminates, plastics and combinations thereof.

11. The air intake shut-off valve of claim 10, wherein the solenoid insulator is made of a G10 Glass reinforced epoxy laminate.

12. The air intake shut-off valve of claim 1, wherein the air inlet and the air outlet are between about 2 inches in diameter to about 14 inches in diameter.

13. The air intake shut-off valve of claim 1, wherein the air inlet and the air outlet are about 4 inches in diameter.

14. The air intake shut-off valve of claim 1, wherein the air intake shut-off valve operates at temperatures from about −4° F. to about 500° F. and at pressures up to about 75 psi.

15. The air intake shut-off valve of claim 1, wherein the solenoid is in the normally closed position and the air intake shut-off valve is in the normally open position.

16. The air intake shut-off valve of claim 1, wherein the service port cover and the solenoid are attached to the valve housing with fasteners, wherein the fasteners are safety wired to prevent loosening.

17. A method of using the air intake shut-off valve of claim 1, comprising the steps:
fluidly connecting an air inlet system of an engine or a machine to the air inlet of the air intake shut-off valve;
fluidly connecting the air outlet of the air intake shut-off valve to a combustion chamber of the engine or the machine;
running the engine or the machine on a mixture of air and fuel;
closing the air intake shut-off valve when the engine or machine speed cannot be controlled by metering fuel rate.

18. The method of claim 17 further comprising the steps:
electrically connecting the air intake shut-off valve to a control system;
monitoring the engine or machine speed using the control system;
closing the air intake shut-off valve when the engine or machine speed reaches a trip threshold.

19. The method of claim 18, wherein the trip threshold is from about 2400 rpm to about 7000 rpm.
